(19) United States
(12) Patent Application Publication
(10) Pub. No.: US 2006/0263682 A1
(43) Pub. Date: Nov. 23, 2006

(54) Battery sheath having ferrite stainless steel layer and rechargeable battery using the same

(76) Inventor: Changsik Kim, Yongin-si (KR)

Correspondence Address: CHRISTIE, PARKER & HALE, LLP, PO BOX 7068, PASADENA, CA, 91109-7068, US

(21) Appl. No.: 11/410,507

(22) Filed: Apr. 24, 2006

(30) Foreign Application Priority Data
Apr. 26, 2005 (KR) 10-2005-0034726

(51) Int. Cl. B32B 15/04; H01M 2/02; H01M 2/08

(52) U.S. Cl. 429/176; 428/457; 429/185

(57) ABSTRACT

A battery sheath having a ferrite stainless steel (SUS) layer is provided. The ferrite SUS layer has a first surface and a second surface. A first insulation layer, such as a cast polypropylene layer, is formed on the first surface of the ferrite SUS layer. A second insulation layer, such as a nylon layer or a polyethylene terephthalate layer, is formed on the second surface of ferrite SUS layer.

### CROSS-REFERENCE TO RELATED APPLICATION

This application claims priority to and the benefit of Korean Patent Application No. 10-2005-0034726, filed on Apr. 26, 2005, the entire content of which is incorporated herein by reference.

### FIELD OF THE INVENTION

The present invention relates to a battery sheath and rechargeable battery using the same. More particularly, the invention relates to a battery sheath having enhanced mechanical strength, excellent workability and reduced thickness.

### BACKGROUND OF THE INVENTION

As is generally known in the art, rechargeable batteries, for example lithium polymer batteries, include electrode assemblies, each of which typically includes a separator positioned between positive and negative electrode collectors. The separator acts as an electrolyte, serving as a medium for ion conduction. The separator also serves as a medium for separation, a function similar to their role in lithium ion batteries. The separator includes a gel-type polymer electrolyte, which is manufactured by impregnating a polymer with an electrolyte, thereby improving ion conductivity.

Unlike lithium ion batteries, lithium polymer batteries can have plate structures and do not require winding process. Therefore, the electrode assembly in a lithium polymer battery can include a number of plates laminated together and can have a square shaped structure. In addition, the electrolyte in a lithium polymer battery is injected into a completely integrated cell, and rarely leaks. Also, the plate structure of the lithium polymer battery makes it unnecessary to apply pressure when making the square shaped structure. Therefore, a thin flexible pouch may be used as the battery sheath, instead of a hard square or cylindrical can.

When a flexible pouch is used as the battery sheath, the thickness of the battery is substantially less than that of a can, enabling more electrode assemblies to be formed within the same volume allowing an increase in battery capacity. The flexible battery sheath allows the battery to take a desired shape and enables the easy mounting of the battery on various electronic appliances.

However, although pouch-type battery sheaths have increased battery capacity and can be processed into various shapes, they have low mechanical strength and are very vulnerable to external impact. For example, a hole can be easily formed in the battery sheath when the battery sheath is pierced by a sharp object (e.g., a needle or nail), and the sheath can be easily torn if, for example, it is bitten by a pet. Furthermore, when a sharp object penetrates the sheath and contacts the internal electrode assembly, a short circuit can occur between the positive and negative electrode collectors, and may cause the battery to catch fire or explode.

In addition, lithium polymer batteries using such a sheath can swell severely at high temperatures. Because the sheath surrounding the electrode assembly is flexible and has a low mechanical strength, the thickness and shape of the battery are easily deformed by gas generated from the internal polymer electrolyte.

### SUMMARY OF THE INVENTION

In accordance with one embodiment of the present invention a battery sheath having a ferrite stainless steel (SUS) layer is provided. The battery sheath has enough mechanical strength to stably protect the battery from external impact. The battery sheath having a ferrite SUS layer also suppresses the battery swelling phenomenon, preventing deformation of the thickness and shape of the battery.

According to another embodiment of the present invention, a battery sheath having a ferrite SUS layer has a reduced thickness and increased mechanical strength, thereby improving battery capacity.

According to another embodiment of the present invention, a battery sheath having a ferrite SUS layer has excellent workability so that there is no blowout or no rupture when forming a cavity for containing an electrode assembly.

One exemplary battery sheath includes a ferrite SUS layer having a first surface and a second surface. A first insulation layer such as a cast polypropylene (CPP) layer is then attached to the first surface of the ferrite SUS layer. A second insulation layer such as a nylon layer or a polyethylene terephthalate (PET) layer is attached to the second surface of ferrite SUS layer.

In other embodiments, the present invention is directed to rechargeable batteries using the battery sheaths. A rechargeable battery may include an electrode assembly having at least one positive electrode collector, at least one negative electrode collector, and at least one separator between the positive and negative electrode collectors. The battery further includes positive and negative electrode tabs coupled to the electrode assembly and extended with a predetermined length from the positive and negative electrode collectors. A sheath includes a first region having a cavity with a predetermined depth for containing the electrode assembly, and a second region adapted to cover the cavity of first region.

### BRIEF DESCRIPTION OF THE DRAWINGS

FIG. 1 is a perspective view of a battery sheath before formation of a cavity, according to one embodiment of the present invention.

FIG. 2 is a cross-sectional view of a battery sheath taken along line 1-1 in FIG. 1.

FIG. 3a is a perspective view of a battery sheath having a cavity for containing an electrode assembly according to one embodiment of the present invention.

FIG. 3b is a magnified view of the region 3b of FIG. 3a.

FIG. 4 is a perspective view of a rechargeable battery according to one embodiment of the present invention.

FIG. 5 is a cross-sectional view of the rechargeable battery taken along line 4-4 in FIG. 4.

### DETAILED DESCRIPTION

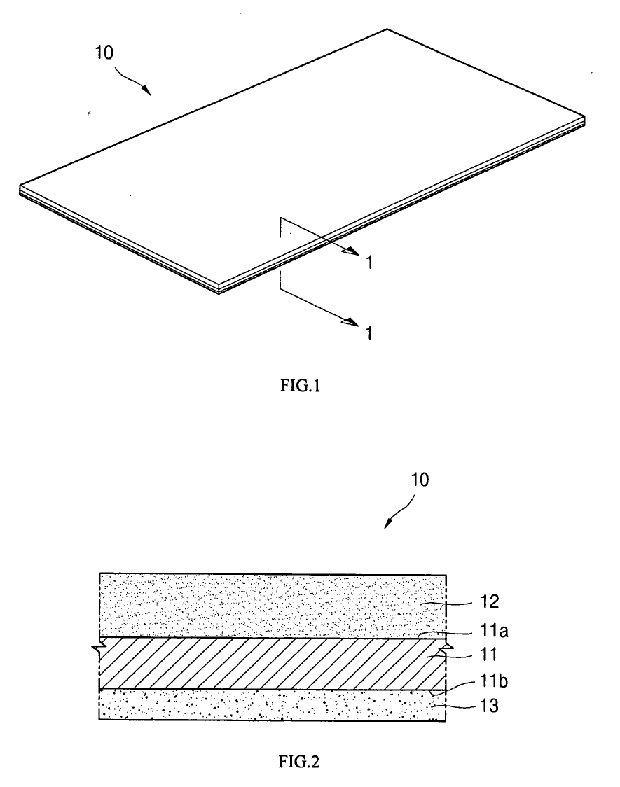

Referring to FIGS. 1 and 2, a battery sheath 10 includes a ferrite SUS layer 11, a first insulation layer 12 formed on a surface of the ferrite SUS layer 11 and a second insulation layer 13 formed on the other surface of the ferrite SUS layer 11.

The ferrite SUS layer 11 has an approximately planar or a completely planar first surface 11a and an approximately planar or a completely planar second surface 11b opposite the first surface 11a. In addition, the thickness of the ferrite SUS layer 11 between the first and second surfaces 11a, 11b ranges from about 10 μm to about 60 μm, which is less than the thickness of prior art sheaths by several microns to tens of microns. Namely, since the ferrite SUS layer 11 has increased mechanical strength because of the material characteristics, it may have more reduced thickness than that of the prior art sheaths. Furthermore, the ferrite SUS layer 11 doesn't need to increase the thickness in order to enhance the elongation ratio related to workability because of the material characteristics. The ferrite SUS layer 11, therefore, may not only reduce the thickness thereof but also keep up the high mechanical strength. For a comparative reference, in the case of using an austenite SUS layer, it needs to increase its thickness in order to enhance the elongation ratio, thus it is difficult for its thickness to stay less than 60 μm. Therefore, in accordance with the present invention more electrode assemblies (not shown) can be contained within the same volume. That is, the capacity of the battery increases.

The ferrite SUS layer 11 may include an alloy having from about 84% to about 88.2% iron, about 0.5% or less carbon, from about 11% to about 18% chromium, and from about 0.3% to about 0.5% manganese. Furthermore, the ferrite SUS layer 11 may include a material selected from the group consisting of Korean Industrial Standard (KS) STS430 and Japanese Industrial Standard (JIS) SUS430. However, it is understood that any suitable material may be used for the ferrite SUS layer 11. Since the ferrite SUS layer has high mechanical strength and high resistance to chemical corrosion, it increases the mechanical strength of the battery sheath 10 and increases the resistance to the electrolyte. The ferrite SUS layer 11, of course, prevents moisture from penetrating the battery. The ferrite SUS layer 11 has an elongation ratio of about 10% to about 60%, enabling easy formation of a cavity (not shown). This elongation ratio prevents the ferrite SUS layer 11 from being damaged during formation of the cavity. The cavity is formed to a predetermined depth by a die, and contains the electrode assembly. For example, the ferrite SUS layer 11 may be annealed in an inactive gas atmosphere at a temperature of hundreds of degrees Celsius to maintain the elongation ratio at about 10% to about 60%. Of course, since the ferrite SUS layer 11 has excellent workability, it has high elongation ratio by itself and there may be no need to be annealing.

Furthermore, the characteristics of the ferrite SUS layer 11 enable suppression of swelling which may occur at higher temperatures after battery assembly. Therefore, deformation of the thickness and shape of the battery is sufficiently prevented. More particularly, massive gas may be generated by decomposition of the electrolyte at high temperature after assembling the battery. And then, the swelling phenomenon, wherein the battery sheath swells outwardly, may occur because of the massive gas. However, since the battery sheath in accordance with the present invention uses the ferrite SUS layer 11 having high mechanical strength, the swelling phenomenon is sufficiently prevented from deforming the battery.

The first insulation layer 12 which is applied to the first surface 11a of the ferrite SUS layer 11 may be a CPP layer. A CPP layer with a thickness of about 30 μm to about 40 μm may be applied to the first surface 11a of the ferrite SUS layer 11. The CPP layer may have a thickness slightly greater than that of the ferrite SUS layer 11 because the CPP layer directly contacts to the electrode assembly and is thermally bonded to each other.

The second insulation layer 13 which is applied to the second surface 11b of the ferrite SUS layer 11 may be one selected from a nylon layer and a PET layer. For example, the nylon layer or the PET layer is applied to the second surface 11b of the ferrite SUS layer 11 by lamination at high temperature. The nylon or the PET layer with a thickness of about 5 μm to about 10 μm is applied to the second surface 11b. The PET layer as the second insulation layer 13 may include an alloy film. More particularly, the PET layer may further include rubber particles for enhancing resistance to impact, a solubilizer surrounding the rubber particles for enhancing adherence, and an adhesive. The rubber particles increase the elongation ratio and the resistance to impact. The solubilizer improves adherence to the ferrite SUS layer 11, and particularly to the second surface 11b of the ferrite SUS layer 11. The adhesive, previously applied to the PET layer enables direct lamination of the PET layer at high temperature without applying any special adhesive to the ferrite SUS layer 11. This further simplifies the manufacturing process of the battery sheath 10. The PET layer may not include an adhesive. In that case, an adhesive is previously formed on the second surface 11b of the ferrite SUS layer 11. The PET layer is then applied to the ferrite SUS layer 11.

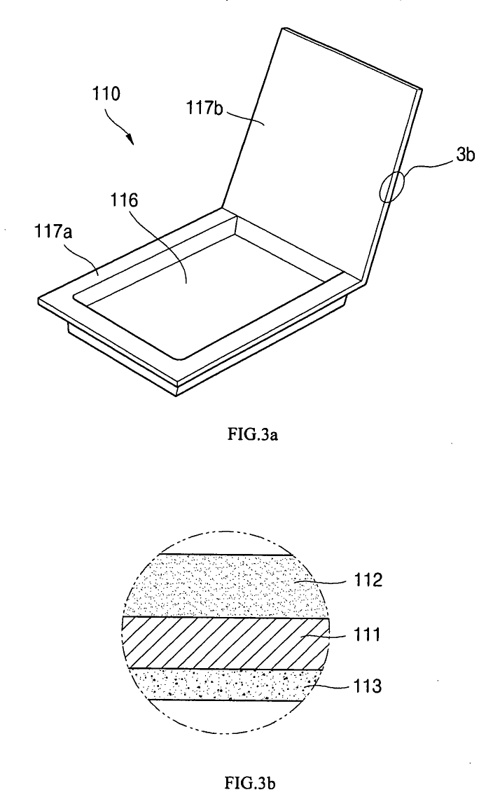

FIG. 3a is a perspective view of a battery sheath 110 according to one embodiment of the present invention. The sheath 110 includes a cavity 116 for containing an electrode assembly. FIG. 3b is a magnified view of region 3b in FIG. 3a. Referring to FIGS. 3a and 3b, the battery sheath 110 includes a first region 117a and a second region 117b which are folded together such that their edges are thermally bonded. The first region 117a may include a cavity 116 having a predetermined width and depth for containing an electrode assembly (not shown). The electrode assembly includes at least one positive electrode collector, at least one negative electrode collector and at least one separator between the positive and negative electrode collectors. The second region 117b may also include a cavity (not shown). A ferrite SUS layer 111, which is the main material of the sheath 110, has an elongation ratio of about 10% to about 60% for preventing the sheath 110 from being damaged during formation of the cavity 116.

The thickness of the first layer 112 is greater than the thickness of the ferrite SUS layer 111, and the thickness of the ferrite SUS layer 111 is greater than the thickness of a second insulation layer 113, such as a PET layer. The first insulation layer 112 is the thickest because the portion of the first insulation layer 112 on the outer peripheral edges of the first and second regions 117a, 117b, respectively, are thermally bonded to each other.

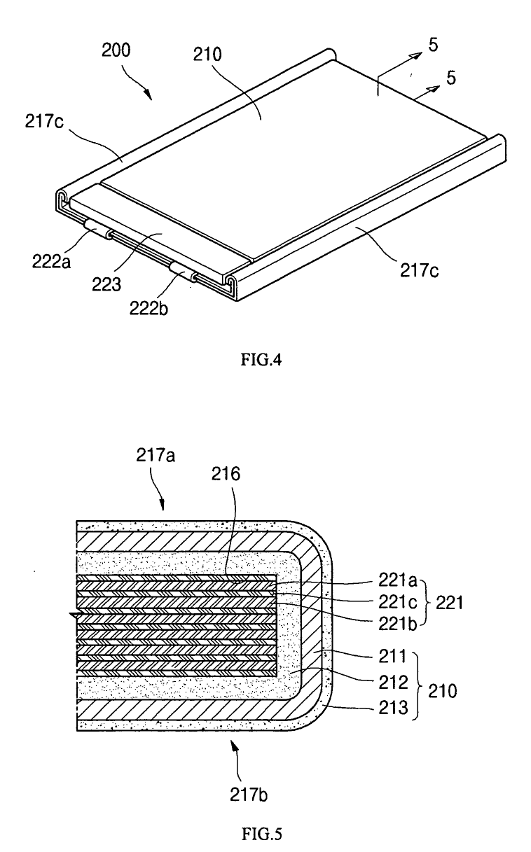

FIG. 4 is a perspective view of a rechargeable battery 200 according to another embodiment of the present invention. FIG. 5 is a cross-sectional view of the rechargeable battery taken along line 4-4 in FIG. 5. As shown, the rechargeable battery 200 includes an electrode assembly 221, a sheath 210, and a protective circuit module 223.

The electrode assembly 221 is formed by laminating at least one positive electrode collector 221a, at least one negative electrode collector 221b, and at least one separator 221c between the positive and negative electrode collectors 221a, 221b, respectively. The positive electrode collector 221a includes lithium cobalt oxide (LiCoLO₂) on aluminum (Al) foil. The negative electrode collector 221b includes graphite on copper (Cu) foil. The separator 221c includes a gel-type polymer electrolyte. At least one positive electrode tab 222a of aluminum is bonded to the aluminum foil of the positive electrode collector 221a, and at least one negative electrode tab 222b of nickel is bonded to the copper foil of the negative electrode collector 221b. The positive and negative electrode tabs 222a, 222b extend a predetermined length from the exterior of the sheath 210.

The sheath 210 includes a first region 217a having a cavity 216 of a predetermined depth for containing the electrode assembly 221, and a second region 217b for covering the cavity 216 of the first region 217a.

The sheath 210 includes a ferrite SUS layer 211. A first insulation layer 212, such as a CPP layer, is applied to a surface of the ferrite SUS layer 211 and a second insulation layer 213, such as a PET layer, is laminated at high temperature on the other surface of the ferrite SUS layer 211. An adhesive (not shown) may optionally be applied between the ferrite SUS layer 211 and the first insulation layer 212. The other adhesive (not shown) may also be optionally applied between the ferrite SUS layer 211 and the second insulation layer 213. The first insulation layer 212 surrounds the electrode assembly 221, and the second insulation layer 213 is positioned on the outermost surface of the sheath 210. The first insulation layers 211 on the outer peripheral edges 217c of the first and second regions 217a, 217b, respectively, of the sheath 210, are thermally bonded to each other and can be folded such that the volume of the sheath 210 is minimized. The remaining features of the sheath 210 are similar to those described above with reference to FIGS. 1 through 3b.

The protective circuit module 223 is attached to a front side of the sheath 210 to protect the battery 200 from voltage or current generated during overcharging or over-discharging. The protective circuit module 223 is electrically connected to the positive and negative electrode tabs 222a, 222b, respectively.

As shown in FIG. 5, the positive electrode 221a is positioned on the outer surface of the electrode assembly 221. Therefore, although the first insulation layer 212 is formed so that the positive electrode 221a contacts the ferrite SUS layer 211, the ferrite SUS layer isn't corroded. Namely, since the ionization tendency of the positive electrode 221a is greater than that of the ferrite SUS layer 211, the positive electrode may be corroded but the ferrite SUS layer 211 is not corroded. Therefore, the electrolyte doesn't leak through the ferrite SUS layer 211.

As described above, the battery sheath includes a ferrite SUS layer having high mechanical strength such that the sheath stably protects the battery from external impact. The high mechanical strength of the sheath enables to have a reduced battery thickness and an increased volume of the electrode assembly. This increases battery capacity. The high mechanical strength of the sheath also suppresses a swelling phenomenon and prevents a deformation of the thickness and shape of the battery. The excellent workability of the battery sheath makes it possible to easily form the cavity for containing the electrode assembly. The high resistance to chemical corrosion of the battery sheath enables the battery to stably prevent from the resistance to the electrolyte and an external acid solution.

Exemplary embodiments of the present invention have been described for illustrative purposes. However, those skilled in the art will appreciate that various modifications, additions and substitutions may be made to the described embodiments without departing from the scope and spirit of the invention as disclosed in the accompanying claims.

What is claimed is:

1. A battery sheath comprising:
a ferrite stainless steel layer having a first surface and a second surface; and
a first insulation layer formed on the first surface of the ferrite stainless steel layer.

2. The battery sheath of claim 1, further comprising a second insulation layer formed on the second surface of the ferrite stainless steel layer.

3. The battery sheath of claim 1, wherein the ferrite stainless steel layer comprises an alloy having:
from about 84% to about 88.2% iron;
about 0.5% or less carbon;
from about 11% to about 18% chromium; and
from about 0.3% to about 0.5% manganese.

4. The battery sheath of claim 1, wherein the ferrite stainless steel layer has a thickness ranging from about 10 μm to about 60 μm.

5. The battery sheath of claim 1, wherein the ferrite stainless steel layer has an elongation ratio ranging from about 10% to about 60%.

6. The battery sheath of claim 1, wherein the first insulation layer comprises a cast polypropylene layer.

7. The battery sheath of claim 1, wherein the second insulation layer comprises a layer selected from a nylon layer and a polyethylene terephthalate layer.

8. The battery sheath of claim 1, further comprising:
a first region having a cavity with a predetermined depth to contain an electrode assembly, the electrode assembly including at least one positive electrode collector, at least one negative electrode collector, and at least one separator between the positive electrode collector and the negative electrode collector; and
a second region covering the first region.

9. The battery sheath of claim 8, wherein first insulation layers corresponding to an outer peripheral edge of the cavity in the first region and the second region are thermally bonded to each other.

10. A battery sheath comprising:
a ferrite stainless steel layer having a first surface and a second surface; and
an insulation layer formed on both the first surface and the second surface.

11. A rechargeable battery comprising:
an electrode assembly having at least one positive electrode collector, at least one negative electrode collector, at least one separator between the positive electrode collector and the negative electrode collector, at least one positive electrode tab, and at least one negative electrode tab, the at least one positive electrode tab and the at least one negative electrode tab being coupled to the electrode assembly and extended by a predetermined length from the respective positive electrode collector and the negative electrode collector; and
a sheath including a ferrite stainless steel layer, the ferrite stainless steel layer having:
a first region having a cavity, the cavity having a depth to contain the electrode assembly, and
a second region covering the cavity of the first region.

12. The rechargeable battery of claim 11, wherein the ferrite stainless steel layer has a first surface and a second surface and includes a first insulation layer formed on the first surface of the ferrite stainless steel layer and a second insulation layer formed on the second surface of the ferrite stainless steel layer.

13. The rechargeable battery of claim 11, wherein the ferrite stainless steel layer comprises an alloy having:
from about 84% to about 88.2% iron;
about 0.5% or less carbon;
from about 11% to about 18% chromium; and
from about 0.3% to about 0.5% manganese.

14. The rechargeable battery of claim 11, wherein the ferrite stainless steel layer has a thickness ranging form about 10 μm to about 60 μm.

15. The rechargeable battery of claim 11, wherein the ferrite stainless steel layer has an elongation ratio ranging from about 10% to about 60%.

16. The rechargeable battery of claim 11, wherein the first insulation layer comprises a cast polypropylene layer.

17. The rechargeable battery of claim 11, wherein the second insulation layer comprises a layer selected from a nylon layer and a polyethylene terephthalate layer.

18. The rechargeable battery of claim 11, wherein first insulation layers corresponding to an outer peripheral edge of the cavity in the first region and the second region are thermally bonded to each other.

19. The rechargeable battery of claim 11, wherein the positive electrode tab and the negative electrode tab are extended with a predetermined length from an exterior of the sheath, a protective circuit module is positioned in the sheath, and the protective circuit module is connected to the positive electrode tab and the negative electrode tab.

20. The rechargeable battery of claim 11, wherein the positive electrode is positioned in the exterior region in the electrode assembly.
